(19) United States
(12) Patent Application Publication
(10) Pub. No.: US 2013/0091464 A1
(43) Pub. Date: Apr. 11, 2013

(54) TILTING CONTROL METHOD AND APPARATUS FOR AUTOMATIC TELLER MACHINE

(71) Applicants: Bo Ik CHANG, Seongnam-si (KR); Hae Jung YIM, Seoul (KR); Yoo Mee MIN, Seongnam-si (KR); Sang Hwan KWEON, Gunpo-si (KR)

(72) Inventors: Bo Ik CHANG, Seongnam-si (KR); Hae Jung YIM, Seoul (KR); Yoo Mee MIN, Seongnam-si (KR); Sang Hwan KWEON, Gunpo-si (KR)

(73) Assignee: NAUTILUS HYOSUNG INC., Seoul (KR)

(21) Appl. No.: 13/340,070

(22) Filed: Dec. 29, 2011

(30) Foreign Application Priority Data
Oct. 11, 2011 (KR) 10-2011-0103754

(51) Int. Cl. G06F 3/048; G07F 19/00

(52) U.S. Cl. 715/811; 235/379

(57) ABSTRACT

A tilting control method for an automatic teller machine (ATM) is disclosed. In particular, according to exemplary embodiments, various types of people operating the ATM may be considered. According to exemplary embodiments, both hardware tilting and software tilting may be executed by mechanically or programmably tilting a display by the operation of a user on the ATM.

### CROSS-REFERENCE TO RELATED APPLICATION

This application claims priority to Korean Patent Application No. 10-2011-0103754, filed on Oct. 11, 2011, which is incorporated herein by reference in its entirety.

### BACKGROUND

1. Field of the Invention

Embodiments of the present invention relate to a tilting control method for an automatic teller machine.

2. Description of the Related Art

Generally, an automatic teller machine (ATM) is a data communication terminal that maintains an online connection to a host computer of a financial institution such as a bank, and provides users with banking services. The users can use a variety of financial transaction services as customers through the automatic teller machine.

An ATM is fixedly installed inside the premises of a bank or a post office, or in a public space without the need for a cashier, and many people visit and operate the automatic teller machine.

Various people operate an automatic teller machine, for example, foreigners, the elderly, people with disabilities, short people, people with weak eyesight, and the like, and thus a broad consideration for various types of people is necessary. For example, an automatic teller machine may provide a function supporting a plurality of languages or a function capable of mechanically tilting a display for the elderly or people with disabilities.

### SUMMARY

Exemplary embodiments of the present invention provide a tilting control method and apparatus for an automatic teller machine (ATM) that may enable both hardware tilting and software tilting by mechanically or programmably tilting a display by the operation of a user on the automatic teller machine.

Exemplary embodiments of the present invention also provide a tilting control method and apparatus for an ATM that, particularly in the case of software tilting, may adjust the sizes or locations of main menu buttons for a financial transaction display of the ATM so that the adjusted main menu buttons may partially hide sub menu buttons, and may enable software tilting of a specific menu button.

Exemplary embodiments of the present invention also provide a tilting control method and apparatus for an ATM that may provide a personalized tilting service.

An exemplary embodiment of the present invention provides a tilting control method for an ATM including displaying a financial transaction display including a plurality of menu buttons, a button for hardware tilting, and a button for software tilting on a touchscreen, determining whether an interaction of a user is related to the button for hardware tilting or the button for software tilting, controlling the movement of a graphic hardware device for the financial transaction display in response to the interaction related to the button for hardware tilting when the interaction occurs with the button for hardware tilting, and re-arranging a plurality of the menu buttons while adjusting the graphic hardware device in response to the interaction related to the button for software tilting when the interaction occurs with the button for software tilting.

In this instance, the re-arranging of a plurality of the menu buttons may include adjusting at least one of sizes and locations of the menu buttons of the financial transaction display.

A plurality of the menu buttons may include main menu buttons related to a financial transaction function and sub menu buttons related to a function other than the financial transaction function, and the re-arranging of a plurality of the menu buttons may include displaying the main menu buttons rather than the sub menu buttons on the financial transaction display at an upper layer, and changing at least one of sizes and locations of the main menu buttons so that at least a portion of the main menu buttons may partially hide the sub menu buttons.

A plurality of the menu buttons may include main menu buttons related to a financial transaction function and sub menu buttons related to a function other than the financial transaction function, and the tilting control method may include receiving a selection input of a specific menu button of the main menu buttons through the financial transaction display when the interaction occurs with the button for software tilting, and in response to the input, displaying the specific main menu button, rather than the other main menu buttons and the sub menu buttons, at an upper layer and changing at least one of a size and a location of the specific main menu button so that at least a portion of the specific main menu button may partially hide at least one of the other main menu buttons and the sub menu buttons.

Also, the method may further include re-arranging menu buttons of a next display in the same manner as the menu buttons of the financial transaction display when the interaction occurs with the button for software tilting and a request for display transition to the next display is made on the financial transaction display.

Also, the method may further include obtaining user identity information of the user through a selection input of the user or card recognition, generating tilting information related to at least one of the hardware tilting and the software tilting, and matching the generated tilting information to the obtained user identity information and storing the tilting information and the user identity information.

Also, the ATM may further include a memory to store user identity information and tilting information related to at least one of the hardware tilting and the software tilting for each of a plurality of users, and the tilting control method may further include obtaining user identity information of a user through a selection input of the user or card recognition, and controlling the movement of the graphic interface hardware device or re-arranging a plurality of the menu buttons while adjusting the graphic hardware device based on tilting information corresponding to the obtained user identity information.

Another exemplary embodiment of the present invention provides a tilting control system for an ATM including a central server to store user identity information and tilting information related to at least one of hardware tilting and software tilting for each of a plurality of users, and an ATM to obtain user identity information of a user through a selection input of the user or card recognition, to receive tilting information corresponding to the obtained user identity information from the central server, and to control the movement of a graphic hardware device for a financial transaction display or re-arrange menu buttons of the financial transaction display while adjusting the graphic interface hardware device, based on the received tilting information.

In this instance, the ATM may display the financial transaction display including a plurality of menu buttons, a button for hardware tilting, and a button for software tilting on a touchscreen, may determine whether an interaction of the user is related to the button for hardware tilting or the button for software tilting through the touchscreen, may control the movement of the graphic hardware device for the financial transaction display in response to the interaction related to the button for hardware tilting when the interaction occurs with the button for hardware tilting, and may re-arrange a plurality of the menu buttons while adjusting the graphic hardware device in response to the interaction related to the button for software tilting when the interaction occurs with the button for software tilting.

Also, the ATM may change at least one of sizes and locations of the menu buttons of the financial transaction display when the interaction occurs with the button for software tilting.

A plurality of the menu buttons may include main menu buttons related to a financial transaction function and sub menu buttons related to a function other than the financial transaction function, and the ATM may display the main menu buttons, rather than the sub menu buttons, at an upper layer on the financial transaction display and may change at least one of sizes and locations of the main menu buttons so that at least a portion of the main menu buttons may partially hide the sub menu buttons.

A plurality of the menu buttons may include main menu buttons related to a financial transaction function and sub menu buttons related to a function other than the financial transaction function, and when the interaction occurs with the button for software tilting, the ATM may receive a selection input of a specific menu button of the main menu buttons through the financial transaction display, and in response to the input, may display the specific main menu button, rather than the other main menu buttons and the sub menu buttons, at an upper layer and may change at least one of a size and a location of the specific main menu button so that a portion of the specific main menu button may partially hide at least one of the other main menu buttons and the sub menu buttons.

When the interaction occurs with the button for software tilting and a request for a display transition to a next display is made on the financial transaction display, the ATM may re-arrange menu buttons of the next display in the same manner as the menu buttons of the financial transaction display.

Also, the ATM may obtain user identity information of the user through a selection input of the user or card recognition, may generate tilting information related to at least one of the hardware tilting and the software tilting, may match the generated tilting information to the obtained user identity information, and may store the tilting information and the user identity information in a memory.

Also, the ATM may further include a memory to store user identity information and tilting information related to at least one of the hardware tilting and the software tilting for each of a plurality of users, and the ATM may obtain user identity information of a user through a selection input of the user or card recognition, and may control the movement of the graphic hardware device or re-arrange a plurality of the menu buttons while adjusting the graphic hardware device, based on tilting information corresponding to the obtained user identity information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a control apparatus performing a tilting control method for an automatic teller machine (ATM) according to an embodiment of the present invention;

FIG. 2 is a diagram illustrating an example of a financial transaction display provided by the control apparatus of FIG. 1;

FIG. 3 is a diagram illustrating operation of a controller of the control apparatus of FIG. 1;

FIGS. 4 to 7 are diagrams illustrating examples of software tilting as provided by the control apparatus of FIG. 1;

FIG. 8 is a diagram illustrating a system performing a tilting control method for an ATM according to another embodiment of the present invention;

FIGS. 9 and 10 are flowcharts illustrating a tilting control method for an ATM according to still another embodiment of the present invention; and

FIG. 11 is a flowchart illustrating a tilting control method for an ATM according to yet another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

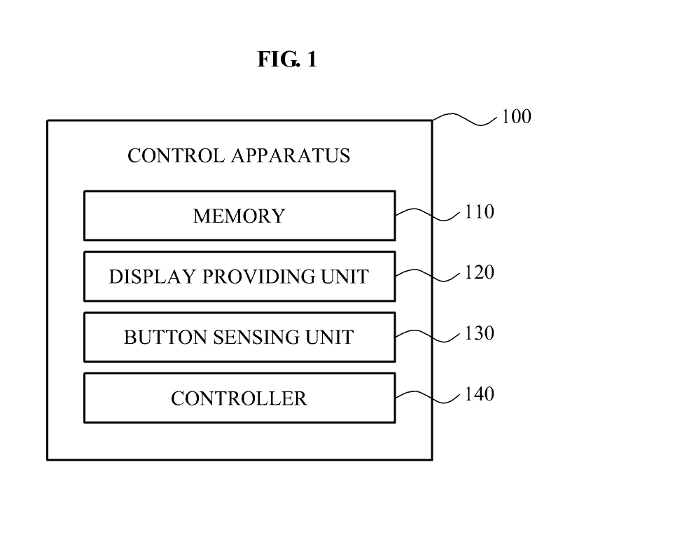

FIG. 1 is a block diagram illustrating a configuration of a control apparatus performing a tilting control method for an automatic teller machine (ATM) according to an embodiment of the present invention.

Referring to FIG. 1, an ATM 100 may include several elements for display tilting. These elements may include a memory 110, a display providing unit 120, a button sensing unit 130, and a controller 140.

The memory 110 may store information necessary for functions of the automatic teller machine 100, and include a static random access memory (SRAM), a dynamic random access memory (DRAM), a read only memory (ROM), and the like.

The display providing unit 120 may display a financial transaction display including a plurality of menu buttons, a button (hereinafter referred to as a first tilting button) for hardware tilting, and a button (hereinafter referred to as a second tilting button) for software tilting on a touchscreen. In this instance, the first tilting button and the second tilting button may be displayed on a touch-sensitive area of the touchscreen, however according to alternative embodiments, the first tilting button and the second tilting button may be fixedly installed at an area other than the touch-sensitive area.

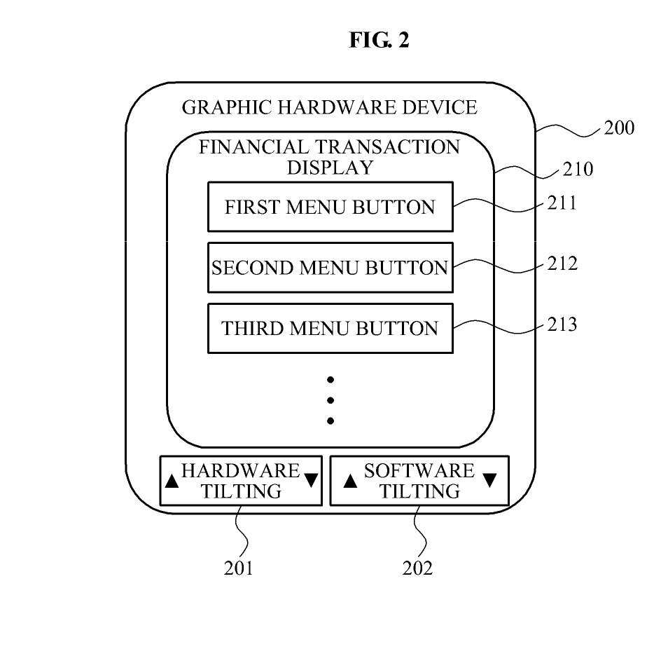

The financial transaction display may be incorporated as shown in FIG. 2.

FIG. 2 is a diagram illustrating an example of a financial transaction display provided by the control apparatus of FIG. 1.

Referring to FIG. 2, a financial transaction display 210 may be provided to a graphic hardware device 200 installed in an ATM. The financial transaction display 210 may display a plurality of menu buttons 211 to 213. A first tilting button 201 related to hardware tilting and a second tilting button 202 related to software tilting may be displayed on the financial transaction display 210 as button images, and may be installed at a part of the graphic hardware device 200 in the physical button form as shown in FIG. 2.

The button sensing unit 130 may determine whether an interaction of a user is related to a button for hardware tilting or a button for software tilting. That is, the button sensing unit 130 may determine whether key data generated by the interaction of a user is key data related to a first tilting button or key data related to a second tilting button.

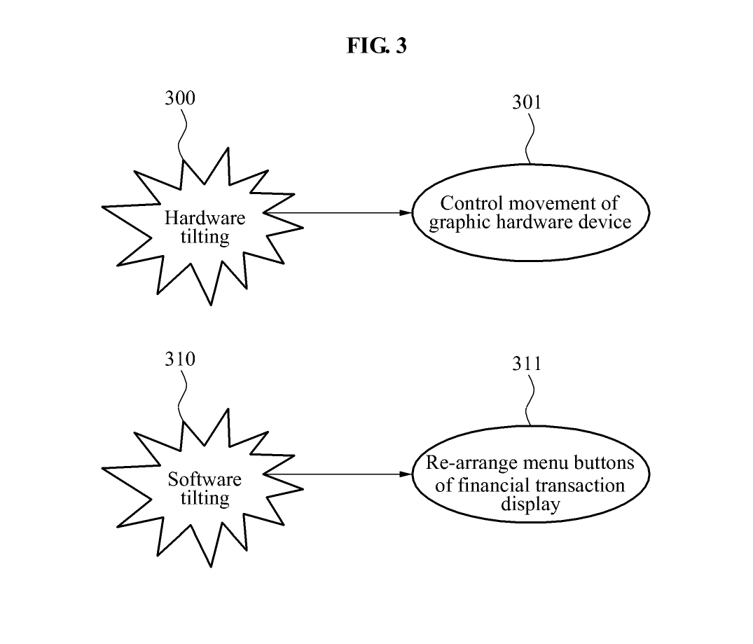

FIG. 3 is a diagram illustrating the operation of the controller 140 of the control apparatus of FIG. 1.

Referring to FIG. 3, when an interaction occurs with a button for hardware tilting 300, that is, when key data generated by the interaction is key data related to a first tilting button, the controller 140 may control the movement of the graphic hardware device for financial transaction display, as indicated by the reference numeral 301. In this instance, the controller 140 may mechanically control the movement of the graphic hardware device to move a panel providing the financial transaction display vertically or horizontally, or to adjust the angular height of the panel.

When an interaction occurs with a button for software tilting 310, that is, when key data generated by the interaction is key data related to a second tilting button, the controller 140 may re-arrange a plurality of menu buttons 311 while adjusting the graphic hardware device, as indicated by the reference numeral 311.

In this instance, the controller 140 may change at least one of sizes and locations of the menu buttons 211 to 213 of the financial transaction display 210.

Further, the tilting buttons may support a function to enable a user to elaborately control the hardware tilting or software tilting. For example, when a user touches a symbol ▴ of the first tilting button 201, the controller 140 may increase the angle of the panel of the graphic hardware device, and when the user touches a symbol ▾, the controller 140 may decrease the angle of the panel of the graphic hardware device. Also, when the user touches a symbol ▴ of the second tilting button 202, the controller 140 may move the menu buttons of the financial transaction display up, and when the user touches a symbol ▾, the controller 140 may move the menu buttons of the financial transaction display down. Also, the controller 140 may move the display at a predetermined interval by executing the hardware tilting or software tilting based on the number of clicks of the tilting buttons.

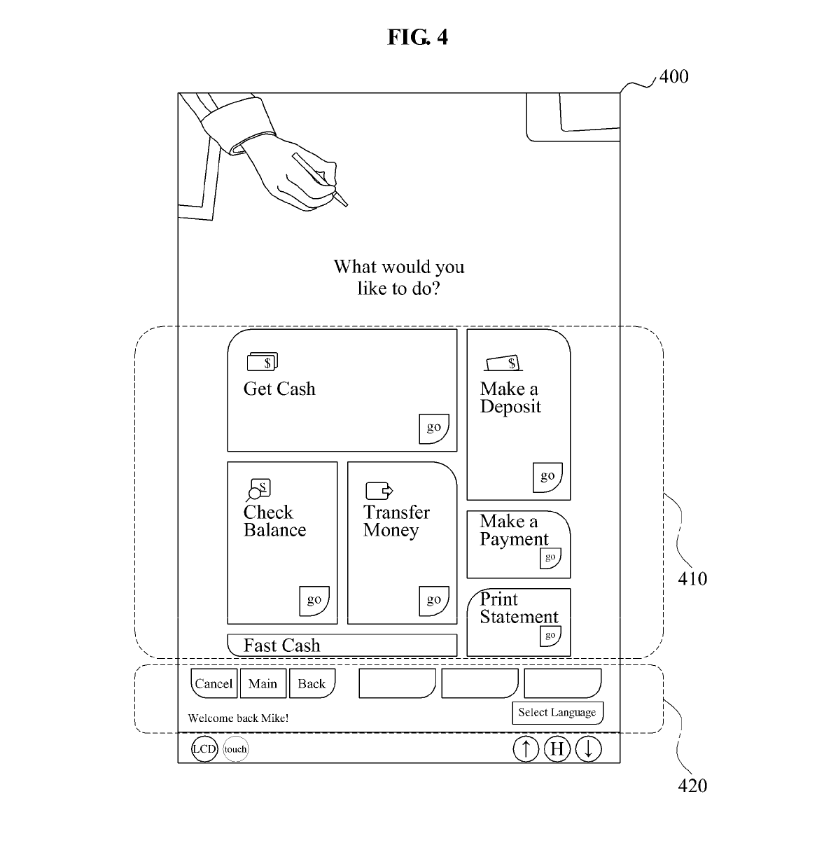

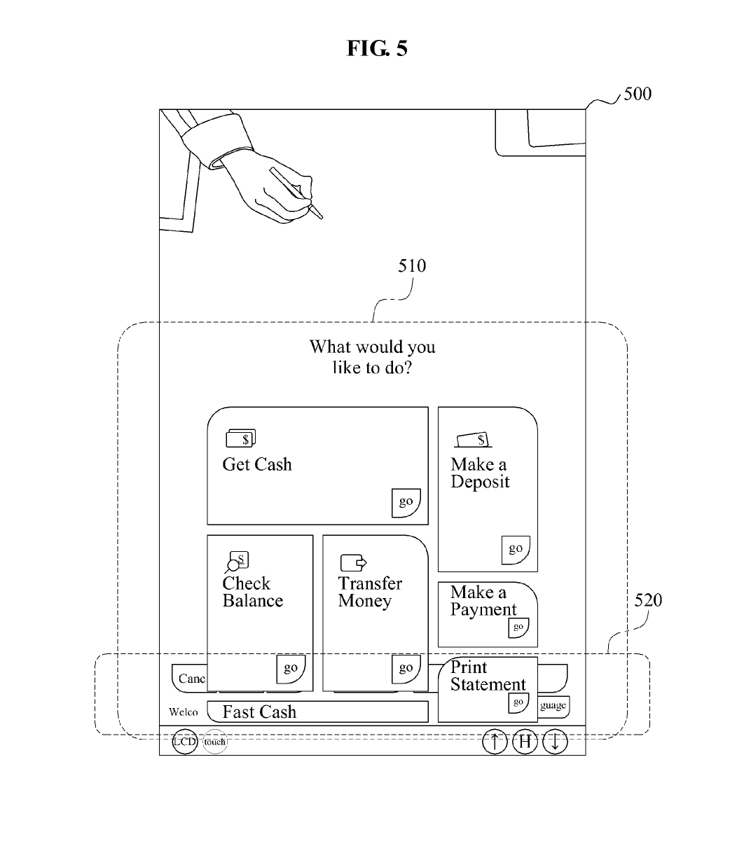

FIGS. 4 to 7 are diagrams illustrating examples of software tilting provided by the control apparatus of FIG. 1. In particular, FIG. 4 illustrates an initial financial transaction display, and FIG. 5 illustrates a financial transaction display with re-arranged menu buttons.

Referring to FIG. 4, a financial transaction display 400 may display a plurality of menu buttons. Here, the menu buttons may be classified into main menu buttons 410 related to a financial transaction function of a user and sub menu buttons 420 related to a function other than the financial transaction function.

The main menu buttons 410 may support a financial transaction service including “Get Cash”, “Check Balance”, “Transfer Money”, “Make a Deposit”, “Make a Payment”, “Print Statement”, and the like. The sub menu buttons 420 may support the control the progress of the financial transaction display 400 including “Cancel”, “Main”, “Back”, and the like.

In this instance, when the interaction occurs with a button for software tilting by a user, the controller 140 may re-arrange the menu buttons.

In particular, according to an exemplary embodiment, the controller 140 may move main menu buttons 510 of a financial transaction display 500 down to a location lower than that of FIG. 4, to allow the elderly or people with disabilities to better view the main menu buttons 510.

Further, the controller 140 may display the main menu buttons 510 over the sub menu buttons 520 to prevent the sub menu buttons 520 from obstructing the re-arranged main menu buttons 510, so that a portion of the sub menu buttons 520 may be hidden.

In other words, the controller 140 may display the main menu buttons 510, rather than the sub menu buttons 520 on the financial transaction display 500, at an upper layer and may change at least one of sizes and locations of the main menu buttons 510 so that at least a portion of the main menu buttons 510 may partially hide the sub menu buttons 520.

Accordingly, even a short or an elderly user may be able to view the main menu buttons in more detail, irrespective of the sub menu buttons.

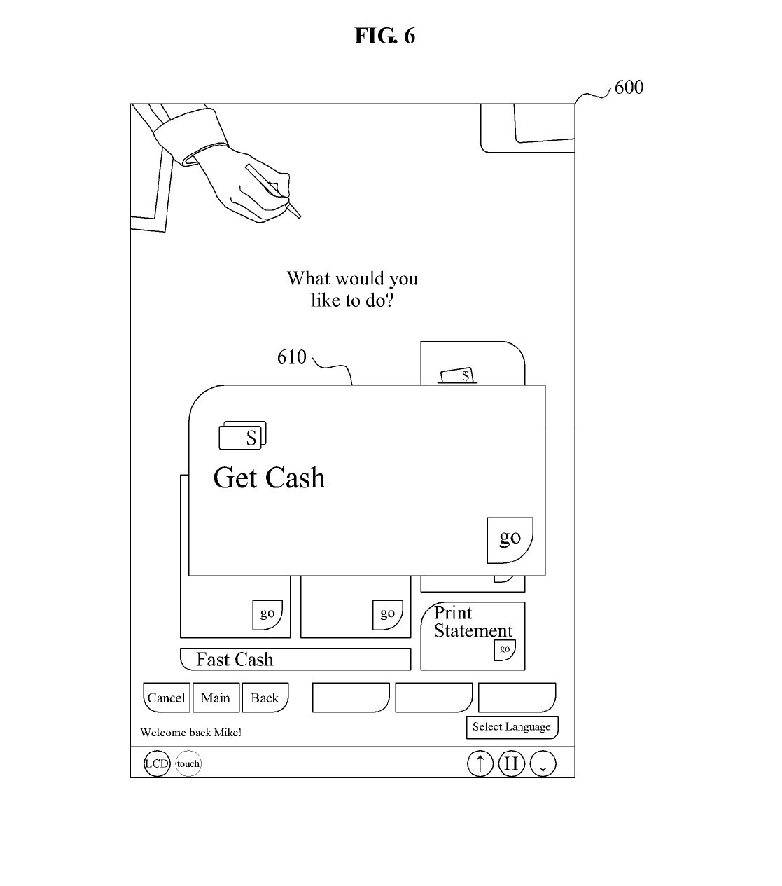

FIG. 6 illustrates another example of re-arrangement of menu buttons. Referring to FIG. 6, the controller 140 may enlarge the size of a specific main menu button 610 to be larger than that of FIG. 4 and may display the enlarged specific main menu button 610 on a financial transaction display 600.

Similarly to FIG. 5, the controller 140 may display the specific main menu button 610 rather than the other buttons at an upper layer and may enlarge the size of the specific main menu button 610 so that a portion of the specific main menu button 610 may partially hide the other buttons.

In this instance, the specific main menu button 610 may be a button selected by a user. That is, a user may select a button to be enlarged using a button for software tilting. For example, a user may press a button for software tilting and then may select and touch a main menu button to be enlarged.

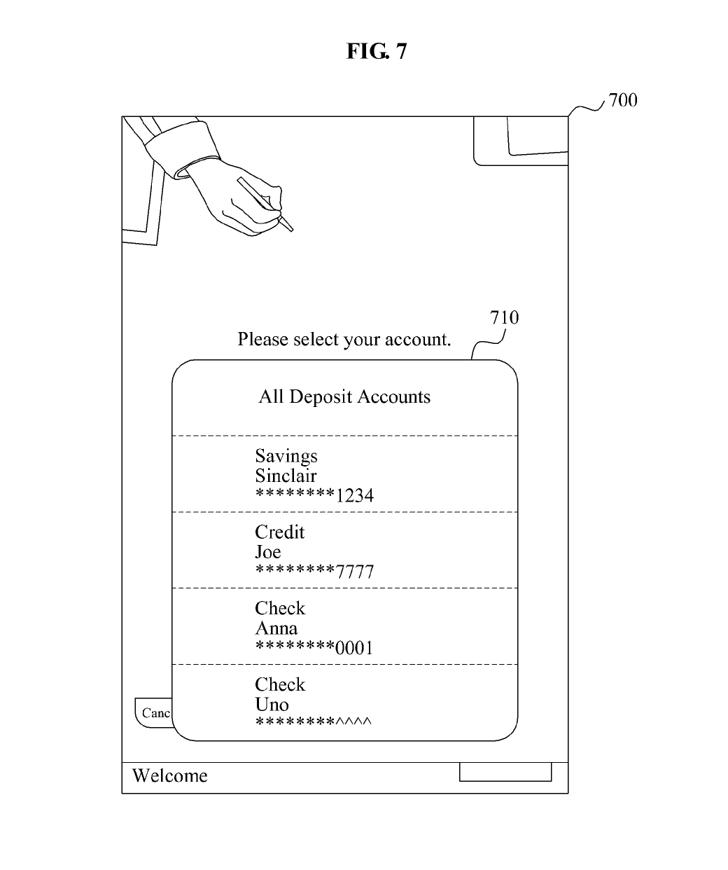

In the case of software tilting, the controller 140 may execute the same tilting on a next display. FIG. 7 illustrates an example of a next display.

Referring to FIG. 7, the controller 140 may have tilting information of a financial transaction display (for example, 400) and then may apply the same tilting to a next display 700.

In other words, when a request for display transition to a next display 700 is made on a financial transaction display after interaction occurs with a button for software tilting, the controller 140 may re-arrange menu buttons of the next display 700 in the same manner as the menu buttons of the financial transaction display. In this instance, the controller 140 may move the menu buttons of the next display 700 or a location of a main page 710 down.

After the controller 140 executes at least one of hardware tilting and software tilting based on interaction of a user, the controller 140 may personalize and manage tilting information of the executed tilting for each user.

The controller 140 may obtain user identity information of a user through a selection input of the user, for example, a touch input, or card recognition. Also, the controller 140 may generate at least one of tilting information related to hardware tilting and tilting information related to software tilting. That is, the tilting information generated by the controller 140 may be information related to at least one of the control of the movement of the graphic hardware device and the re-arrangement of a plurality of the menu buttons. Also, the controller 140 may match the generated tilting information with user identity information and may store the tilting information and the user identity information in the memory 110.

Accordingly, the controller 140 may store user identity information and tilting information related to at least one of hardware tilting and software tilting for each of a plurality of users.

Further, when a next user visits thereafter, the controller 140 may obtain user identity information of the next user through a selection input of the next user or card recognition. The controller 140 may automatically control the movement of the graphic hardware device or may automatically re-arrange a plurality of menu buttons while adjusting the graphic hardware device, based on tilting information corresponding to the obtained user identity information.

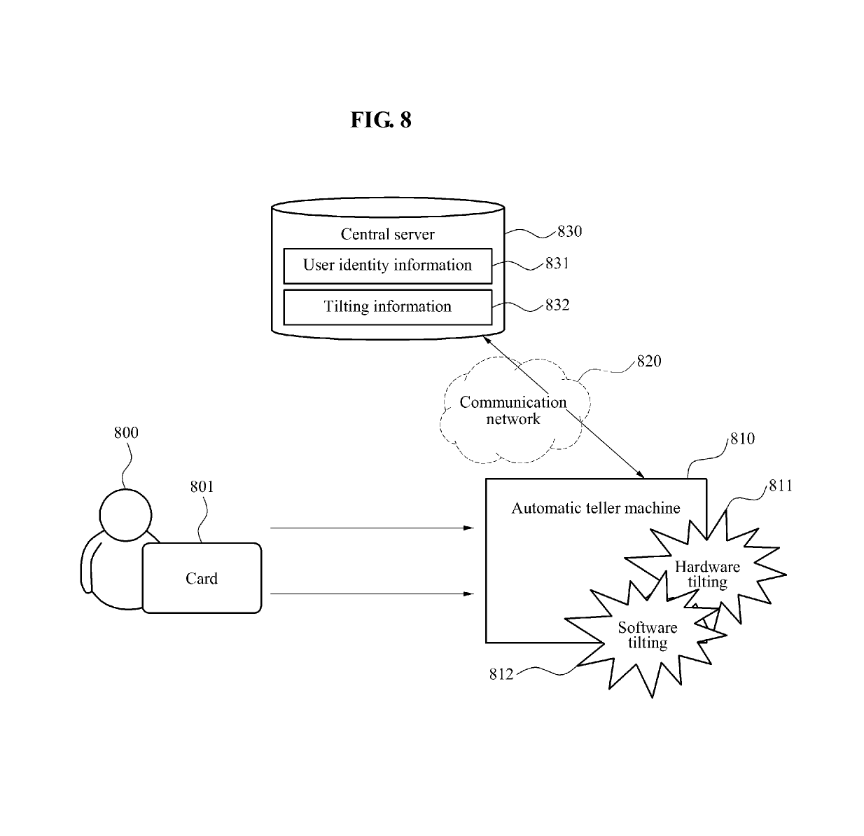

FIG. 8 is a diagram illustrating a system performing a tilting control method for an ATM according to another embodiment of the present invention.

Referring to FIG. 8, an ATM 810 may link to a central server 830 via a communication network 820 and may receive a selection input from a user 800 or recognize a card 801 of the user 800.

The central server 830 may store user identity information and tilting information related to at least one of software tilting and hardware tilting for each of a plurality of users.

The ATM 810 may obtain user identity information of the user 800 through the selection input of the user 800 or the recognition of the card 810, and may receive tilting information corresponding to the obtained user identity information from the central server 830. Based on the received tilting information, the ATM 810 may automatically control the movement of the graphic hardware device for the financial transaction display or may automatically re-arrange a plurality of menu buttons of the financial transaction display while adjusting the graphic hardware device. The re-arrangement may be implemented in the same manner as those of FIGS. 1 to 7.

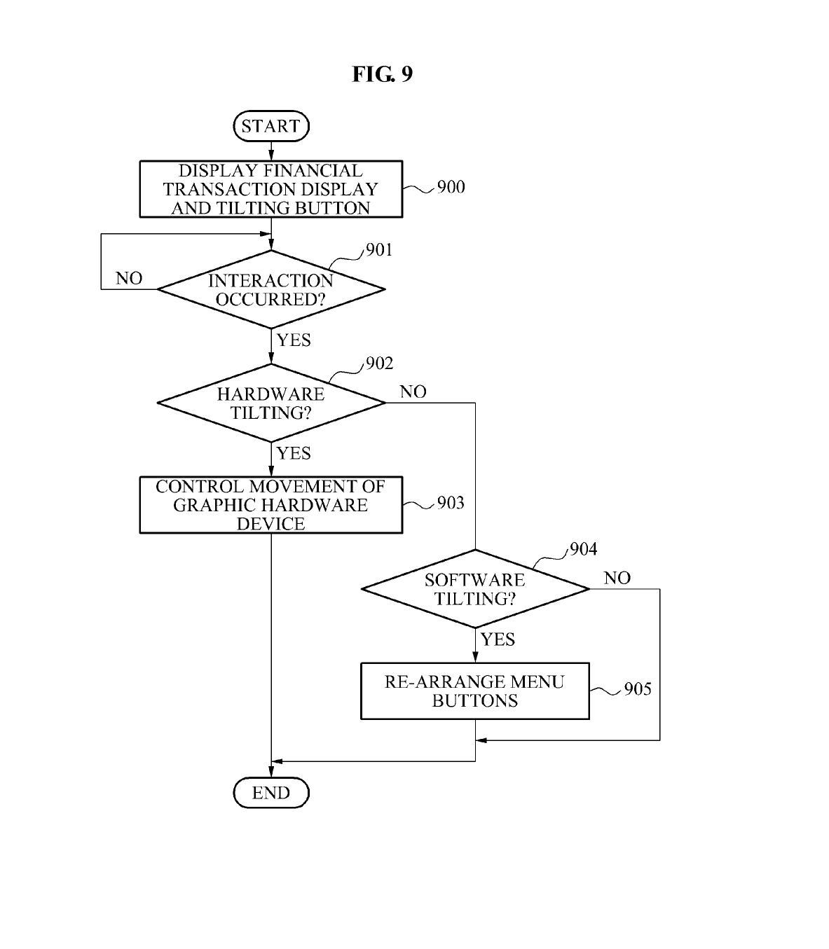

FIG. 9 is a flowchart illustrating a tilting control method for an ATM according to yet another embodiment of the present invention. The tilting control method may be performed by a tilting control apparatus installed in the ATM.

Referring to FIG. 9, in operation 900, the tilting control apparatus may display a financial transaction display including a plurality of menu buttons, a button for hardware tilting, and a button for software tilting on a touchscreen.

In operation 901, the tilting control apparatus may determine whether an interaction of a user occurred, and when interaction of a user occurred, the tilting control apparatus may determine whether the interaction is related to a button for hardware tilting, in operation 902.

In operation 903, when the interaction is related to a button for hardware tilting, the tilting control apparatus may control the movement of the graphic hardware device for the financial transaction display.

In operation 904, when the interaction is not related to a button for hardware tilting, the tilting control apparatus may determine whether the interaction of the user is related to a button for software tilting.

In operation 905, when the interaction of the user is related to a button for software tilting, the tilting control apparatus may re-arrange a plurality of menu buttons while adjusting the graphic hardware device. The re-arrangement may follow FIGS. 5 to 7.

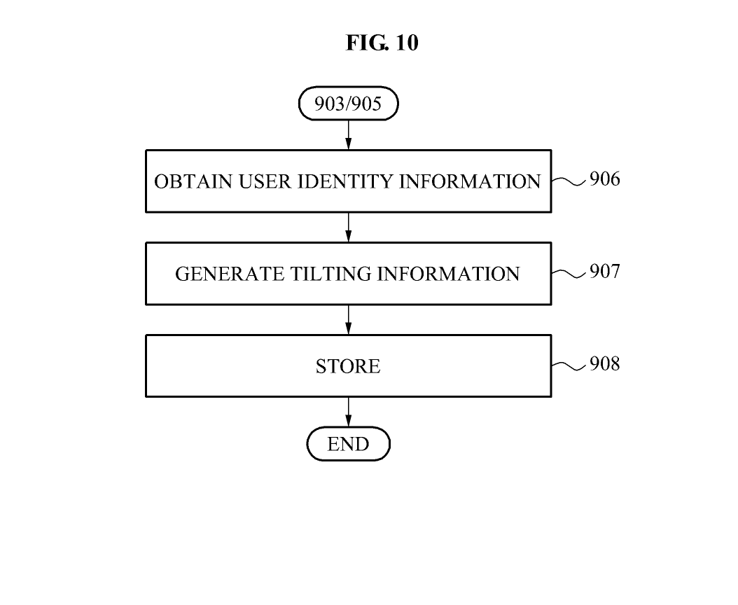

Further, the tilting control apparatus may provide a personalized tilting control. In this instance, the tilting control apparatus may further perform the process of FIG. 10.

Referring to FIG. 10, in operation 906, the tilting control apparatus may obtain user identity information of the user through a selection input of the user or card recognition.

In operation 907, the tilting control apparatus may generate tilting information related to at least one of hardware tilting and software tilting.

In operation 908, the tilting control apparatus may match the generated tilting information to the user identity information and may store the tilting information and the user identity information. Further, the tilting control apparatus may upload the stored tilting information and user identity information to the central server via the communication network.

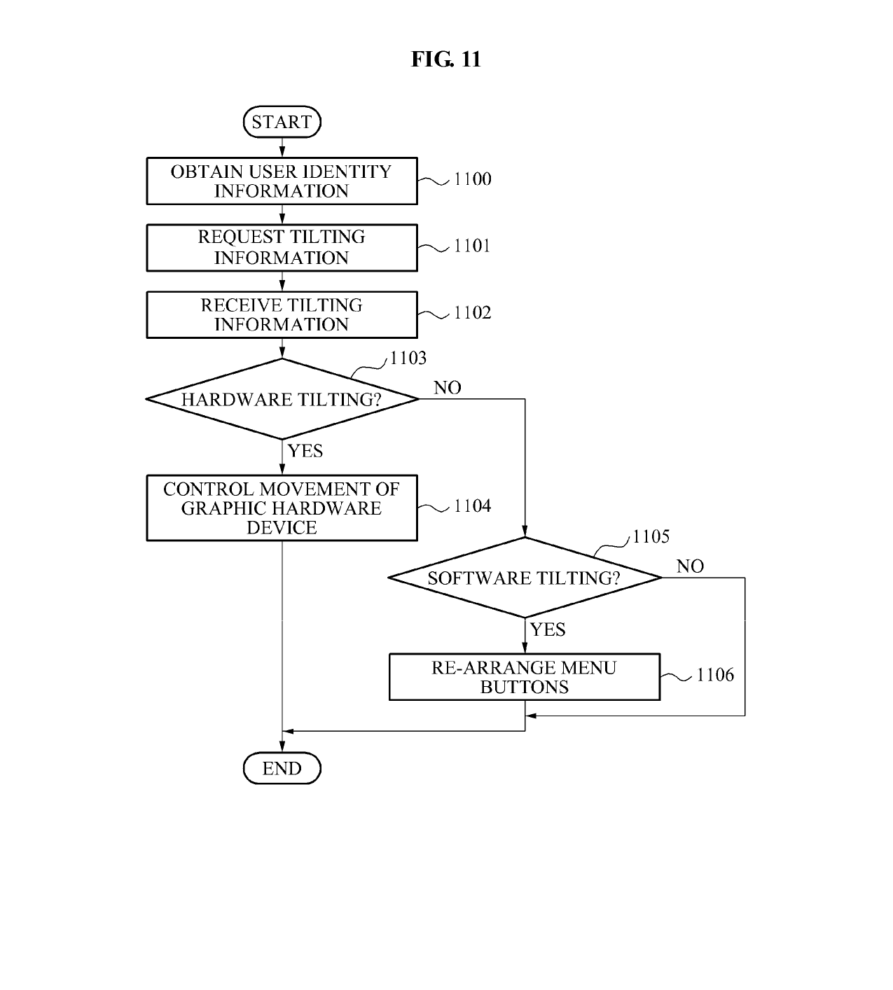

FIG. 11 is a flowchart illustrating a tilting control method for an ATM according to still another embodiment of the present invention. The tilting control method may be performed by a tilting control apparatus installed in the ATM. The tilting control apparatus may link to a central server via a communication network. The central server may organize and store user identity information and tilting information related to at least one of software tilting and hardware tilting for each of a plurality of users.

In operation 1100, the tilting control apparatus may obtain user identity information of a user through a selection input of the user or card recognition.

In operation 1101, the tilting control apparatus may request the central server for tilting information corresponding to the user identity information.

In response to the request, the tilting control apparatus may receive tilting information corresponding to the user identity information from the central server in operation 1102.

In operation 1103, the tilting control apparatus may determine whether tilting to be provided to the user is hardware tilting based on the tilting information. When hardware tilting is to be provided, the tilting control apparatus may control the movement of the graphic hardware device for the financial transaction display based on the tilting information in operation 1104.

When tilting to be provided to the user is not hardware tilting, the tilting control apparatus may determine whether software tilting is to be provided in operation 1105. When software tilting is to be provided, the tilting control apparatus may re-arrange the menu buttons of the financial transaction display based on the tilting information in operation 1106.

According to embodiments of the present invention, a user may execute both hardware tilting and software tilting by mechanically or programmably tilting a display by the operation of the user on an automatic teller machine (ATM).

In particular, the user may see menu buttons with adjusted sizes or locations on a financial transaction display of the ATM.

Also, the user may be provided with a personalized tilting service for the user, on-line or off-line, by inputting information identifying the user or scanning a card of the user.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A tilting control method for an automatic teller machine (ATM), the method comprising:
displaying a financial transaction display including a plurality of menu buttons, a button for hardware tilting, and a button for software tilting on a touchscreen;
determining whether an interaction of a user is related to the button for hardware tilting or the button for software tilting;
controlling the movement of a graphic hardware device for the financial transaction display in response to the interaction related to the button for hardware tilting when the interaction occurs with the button for hardware tilting; and
re-arranging a plurality of the menu buttons while adjusting the graphic hardware device in response to the interaction related to the button for software tilting when the interaction occurs with the button for software tilting.

2. The method of claim 1, wherein the re-arranging of a plurality of the menu buttons includes adjusting at least one of sizes and locations of the menu buttons of the financial transaction display.

3. The method of claim 1, wherein a plurality of the menu buttons includes main menu buttons related to a financial transaction function and sub menu buttons related to a function other than the financial transaction function,
the re-arranging of a plurality of the menu buttons includes displaying the main menu buttons rather than the sub menu buttons on the financial transaction display at an upper layer and changing at least one of sizes and locations of the main menu buttons so that at least a portion of the main menu buttons partially hides the sub menu buttons.

4. The method of claim 1, wherein a plurality of the menu buttons includes main menu buttons related to a financial transaction function and sub menu buttons related to a function other than the financial transaction function,
the method including:
receiving a selection input of a specific menu button of the main menu buttons through the financial transaction display when the interaction occurs with the button for software tilting; and
in response to the input, displaying the specific main menu button rather than the other main menu buttons and the sub menu buttons at an upper layer and changing at least one of a size and a location of the specific main menu button so that at least a portion of the specific main menu button partially hides at least one of the other main menu buttons and the sub menu buttons.

5. The method of claim 1, further comprising re-arranging menu buttons of a next display in the same manner as the menu buttons of the financial transaction display when the interaction occurs with the button for software tilting and a request for display transition to the next display is made on the financial transaction display.

6. The method of claim 1, further comprising:
obtaining user identity information of the user through a selection input of the user or card recognition;
generating tilting information related to at least one of the hardware tilting and the software tilting; and
matching the generated tilting information to the obtained user identity information and storing the tilting information and the user identity information.

7. The method of claim 1, wherein the ATM further includes a memory to store user identity information and tilting information related to at least one of the hardware tilting and the software tilting for each of a plurality of users,
the method further comprising:
obtaining user identity information of a user through a selection input of the user or card recognition; and
controlling the movement of the graphic hardware device or re-arranging a plurality of the menu buttons while adjusting the graphic hardware device based on tilting information corresponding to the obtained user identity information.

8. A tilting control system for an automatic teller machine (ATM), the system comprising:
a central server to store user identity information and tilting information related to at least one of hardware tilting and software tilting for each of a plurality of users; and
an ATM to obtain user identity information of a user through a selection input of the user or card recognition, to receive tilting information corresponding to the obtained user identity information from the central server, and to control the movement of a graphic hardware device for a financial transaction display or re-arrange menu buttons of the financial transaction display while adjusting the graphic hardware device, based on the received tilting information.

9. The system of claim 8, wherein the ATM displays the financial transaction display including a plurality of menu buttons, a button for hardware tilting, and a button for software tilting on a touchscreen, determines whether an interaction of the user is related to the button for hardware tilting or the button for software tilting through the touchscreen, controls the movement of the graphic hardware device for the financial transaction display in response to the interaction related to the button for hardware tilting when the interaction occurs with the button for hardware tilting, and re-arranges a plurality of the menu buttons while adjusting the graphic hardware device in response to the interaction related to the button for software tilting when the interaction occurs with the button for software tilting.

10. The system of claim 9, wherein the ATM changes at least one of sizes and locations of the menu buttons of the financial transaction display when the interaction occurs with the button for software tilting.

11. The system of claim 9, wherein a plurality of the menu buttons includes main menu buttons related to a financial transaction function and sub menu buttons related to a function other than the financial transaction function,
the ATM displays the main menu buttons rather than the sub menu buttons at an upper layer on the financial transaction display and changes at least one of sizes and locations of the main menu buttons so that at least a portion of the main menu buttons partially hides the sub menu buttons.

12. The system of claim 9, wherein a plurality of the menu buttons includes main menu buttons related to a financial transaction function and sub menu buttons related to a function other than the financial transaction function,
when the interaction occurs with the button for software tilting, the ATM receives a selection input of a specific menu button of the main menu buttons through the financial transaction display, and in response to the input, displays the specific main menu button rather than the other main menu buttons and the sub menu buttons at an upper layer and changes at least one of a size and a location of the specific main menu button so that a portion of the specific main menu button partially hides at least one of the other main menu buttons and the sub menu buttons.

13. The system of claim 9, wherein when the interaction occurs with the button for software tilting and a request for display transition to a next display is made on the financial transaction display, the ATM re-arranges menu buttons of the next display in the same manner as the menu buttons of the financial transaction display.

14. The system of claim 9, wherein the ATM obtains user identity information of the user through a selection input of the user or card recognition, generates tilting information related to at least one of the hardware tilting and the software tilting, matches the generated tilting information to the obtained user identity information, and stores the tilting information and the user identity information in a memory.

15. The system of claim 9, wherein the ATM further includes a memory to store user identity information and tilting information related to at least one of the hardware tilting and the software tilting for each of a plurality of users,
the ATM obtains user identity information of a user through a selection input of the user or card recognition, and controls the movement of the graphic hardware device or re-arranges a plurality of the menu buttons while adjusting the graphic hardware device, based on tilting information corresponding to the obtained user identity information.
